(19) United States
(12) Patent Application Publication
(10) Pub. No.: US 2005/0149709 A1
(43) Pub. Date: Jul. 7, 2005

(54) Prediction based indexed trace cache

(75) Inventor: Stephan J. Jourdan, Portland, OR (US)

Correspondence Address: KENYON & KENYON, Suite 600, 333 W. San Carlos Street, San Jose, CA, 95110-2711, US

(73) Assignee: Intel Corporation

(21) Appl. No.: 10/748,285

(22) Filed: Dec. 29, 2003

(51) Int. Cl. G06F 9/30

(52) U.S. Cl. 712/239; 712/214

(57) ABSTRACT

A system and method for compensating for branching instructions in trace caches is disclosed. A branch predictor uses the branching behavior of previous branching instructions to select between several traces beginning at the same linear instruction pointer (LIP) or instruction. The fetching mechanism of the processor selects the trace that most closely matches the previous branching behavior. In one embodiment, a new trace is generated only if a divergence occurs within a predetermined location. A divergence is a branch that is recorded as following one path (i.e. taken) and during execution follows a different path (i.e. not taken).

### BACKGROUND OF THE INVENTION

The present invention pertains to a method and apparatus for storing traces in a trace cache. More particularly, the present invention pertains to storing alternate traces in a trace cache to represent branching instructions.

A processor may have an instruction fetch mechanism 110 and an instruction execution mechanism 120, as shown in FIG. 1. An instruction buffer 130 separates the fetch 110 and execution mechanisms 120. The instruction fetch mechanism 110 acts as a “producer” which fetches, decodes, and places instructions into the buffer 130. The instruction execution engine 120 is the “consumer” which removes instructions from the buffer 130 and executes them, subject to data dependence and resource constraints. Control dependencies 140 provide a feedback mechanism between the producer and consumer. These control dependencies may include branches or jumps. A branching instruction is an instruction that may have one following instruction under one set of circumstances and a different following instruction under a different set of circumstances. A jump instruction may skip over the instructions that follow it under a specified set of circumstances.

Because of branches and jumps, instructions to be fetched during any given cycle may not be in contiguous cache locations. The instructions are placed in the cache in their compiled order. Hence, there must be adequate paths and logic available to fetch and align noncontiguous that does not branch or code with large basic blocks. That is, it is not enough for the instructions to be present in the cache, it must also be possible to access them in parallel.

To remedy this, a special instruction cache has been used that captures dynamic instruction sequences. This structure is called a trace cache because each line stores a snapshot, or trace, of the dynamic instruction stream. A trace is a sequence of instructions, broken into a set of chunks, starting at any point in the dynamic instruction stream. A trace is fully specified by a starting address and a sequence of branch outcomes describing the path followed. The first time a trace is encountered, it is allocated a line in the trace cache. The line is filled as instructions are fetched from the instruction cache. If the same trace is encountered again in the course of executing the program, i.e. the same starting address and predicted branch outcomes, it will be available in the trace cache and is fed directly to the decoder. Otherwise, fetching proceeds normally from the instruction cache. Some implementations may have microprocessors that translate instructions to micro-operations. The trace cache in these instances will record such micro-operations as if they were instructions.

Two methods for organizing the trace cache have been proposed. The first and most common method, called partial matching, indexes the trace cache with the linear instruction pointer (LIP) of the first instruction of the trace cache. All the instructions common to the built path and the predicted path are fetched and the next lookup of the instruction cache will be done at the point of divergence. If no point of divergence occurs, the next sequential linear instruction pointer will be used. However, certain processors perform block allocation, and invalid instructions from a trace still consume bandwidth and reorder buffer entries, leading to fragmentation issues.

A second method is to index the trace cache with both the LIP of the first instruction and the prediction of future branches. Traces are then fetched as a whole. However this leads to replication, and waiting for future predictions is not practical.

### BRIEF DESCRIPTION OF THE DRAWINGS

FIG. 1 is a block diagram of an embodiment of a prior art processor.

FIG. 2 illustrates in a block diagram one embodiment of a trace according to the present invention.

FIG. 3 shows in a block diagram one embodiment of a simplified architecture of a processor according to the present invention.

FIG. 4 illustrates in a flowchart one embodiment of a process for using a stewed-indexed trace cache according to the present invention.

FIG. 5 shows a computer system that may incorporate embodiments of the present invention.

### DETAILED DESCRIPTION

A system and method for compensating for branching instructions in trace caches is disclosed. The fetching mechanism uses the branching behavior of previous branching instructions to select between several traces beginning at the same linear instruction pointer (LIP) or instruction. The fetching mechanism of the processor selects the trace that most closely matches the previous branching behavior. In one embodiment, a new trace is generated only if a divergence occurs within a predetermined location. A divergence is a branch that is recorded as following one path (i.e. taken) and during execution follows a different path (i.e. not taken).

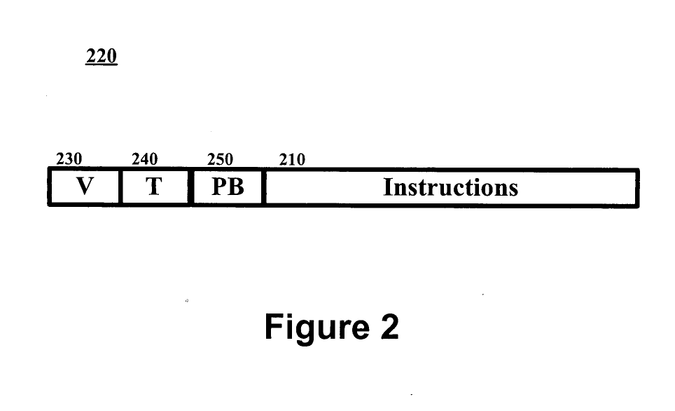

FIG. 2 illustrates in a block diagram one example of a trace 200. A trace includes a set of instructions 210. The instructions 210 may be divided into a set of blocks, with each block containing a set number of instructions. The block may represent the number of instructions retrieved in a single fetch. A header 220 containing administrative information may precede the instructions 210. The header 220 may contain a validity bit 230 indicating that the trace is a valid trace. The header may contain a tag 240 identifying the starting address of the trace. A set of past branch flags (PB) 250 may indicate whether the previous set of branches were taken or not taken. The size of the previous set of branches may vary as desired.

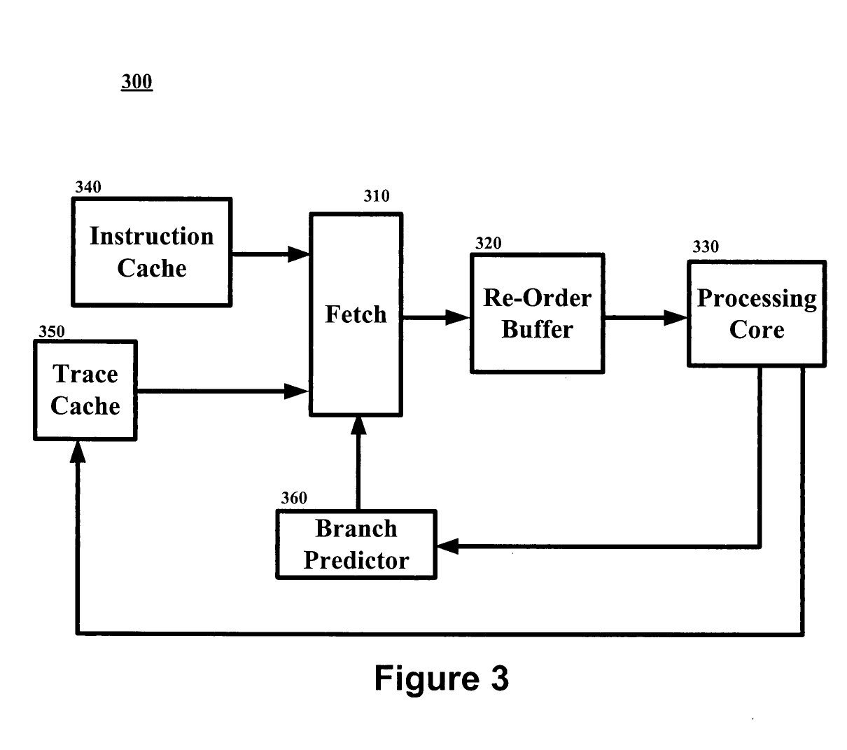

FIG. 3 shows in a block diagram one embodiment of a simplified architecture of a processor 300. A fetch mechanism 310 may retrieve instructions to be allocated to a re-order buffer 320. The processing core 330 may then execute the instructions in the re-order buffer 320. The first time a set of instructions is to be executed, the fetch mechanism 310 may retrieve the instructions from an instruction cache 340. After the processing core 330 has fetched the instructions, they may be stored as a trace in a trace cache 350. The next time that same set of instructions is needed by the processing core 330, the fetching mechanism 310 may retrieve them as a trace from the trace cache.

From the previous set of branching instructions before the present instruction, a profile may be built. For example, the previous four branches may have been not taken, taken, not taken, and taken (NTNT). The profile may be in reverse order. In this example, the first branch (N) represents the branch immediately preceding the present instruction while the fourth branch (T) represents the branch four branches before the present instruction. The branch predictor 360 may then have the fetching mechanism 310 look up the traces in the trace cache that are at that LIP address. Multiple traces may be pre-selected. The fetching mechanism 310 may then select the trace whose previous branch flags most closely match the previous branch pattern. The fetching mechanism 310 may give greater weight to traces that match the pattern closest to the present instruction. For example, if the first matching trace has a pattern of TNNN, the second matching trace has a pattern of TTNT, and the third matching trace has a pattern of NNNN, the fetching mechanism 310 would retrieve the third matching trace. This would be because the pattern NNNN matches NTNT the most early in the trace. In an alternate example, if the previous four branches had been TTTT, the second matching trace would be retrieved. This would be because the pattern TTNT matches TTTT the most early in the trace. The number of previous branches used may be altered as necessary to best predict the trace. The number of previous branches used do not have to match the number of branches in the trace to be selected.

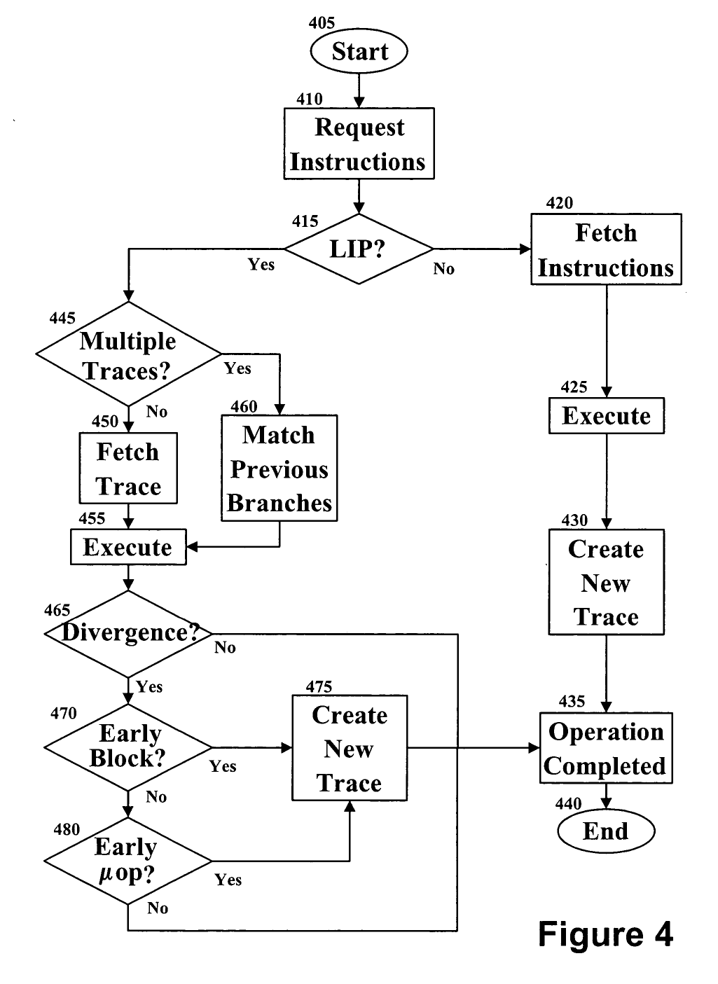

FIG. 4 illustrates in a flowchart one embodiment of a process for using a branch history-indexed trace cache. The process starts (Block 405), when the processing core 330 requests some instructions at a specified LIP (Block 410). The fetching mechanism 310 checks the trace cache to see if the appropriate trace is present at that LIP or beginning instruction (Block 415). If no trace is present in the trace cache, instructions are fetched (Block 420). The processing core 330 then executes the instructions (Block 425). A new trace is created for that set of instructions and stored in the trace cache 360 (Block 430). The operation is then completed (Block 435), ending the process (Block 440).

If a trace is present in the trace cache at that LIP (Block 415), then the fetch mechanism 310 determines whether multiple traces are stored in the trace cache with that LIP (Block 445). If a single trace is present (Block 445), that trace is fetched (Block 450), and the processing core 330 executes those instructions (Block 455). If multiple traces are present (Block 445), the most recent previous branches are matched against the previous branch flags of each of the traces (Block 450). The trace whose previous branches most closely match is fetched and the processing core 330 executes that trace (Block 455).

In one embodiment, while the trace is executed (Block 455), if no divergence occurs (Block 465), the operation is completed (Block 435), and the process is over (Block 440). If a divergence does occur (Block 465), and if it occurs in an early block of the trace (Block 470), a new trace is created representing the trace in which the divergence occurs (Block 475). The operation is completed (Block 435), and the next instruction indicated by the linear instruction pointer is retrieved until the process is over (Block 440). If the divergence does not occur in an early block of the trace (Block 470), but does occur in an early instruction within that block (Block 480), a new trace is created representing the trace in which the divergence occurs (Block 475). The operation is completed (Block 435), and the next instruction indicated by the linear instruction pointer is retrieved until the process is over (Block 440).

In one embodiment, if the divergence occurs in the final instruction of a block, no alternate trace is created regardless of how early in the trace the block is. This is because the divergence at this point does not create fragmentation. In a further embodiment, whether or not to create an alternate trace is determined by considering a position of the divergence in a block, and the position of the block in the trace. For example, a trace may have eight blocks and eight instructions in a block. If the block position plus the instruction position is less than eight, no alternate trace is created. If the block position plus the instruction position is eight or more, an alternate trace is created. However, if a divergence occurs during the third instruction of the sixth block, no alternate trace is created. However, a divergence occurring during the fifth instruction of the second block results in an alternate trace being created. All these numbers are purely for the purpose of example and any number may be assigned to each variable as needed. Furthermore, this heuristic may be modified to yield higher efficiency without departing from this embodiment of the invention.

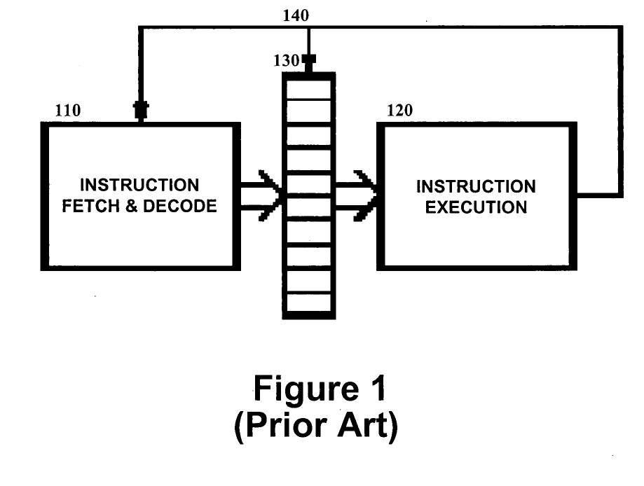

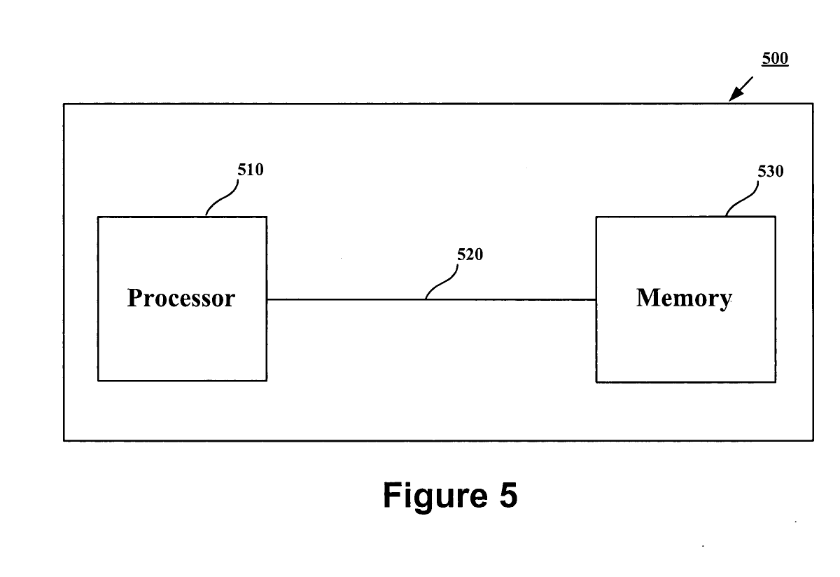

FIG. 5 shows a computer system 500 that may incorporate embodiments of the present invention. The system 500 may include, among other components, a processor 510, a memory 530 (e.g., such as a Random Access Memory (RAM)), and a bus 520 coupling the processor 510 to memory 530. In this embodiment, processor 510 operates similarly to the processor 100 of FIG. 1 and executes instructions provided by memory 530 via bus 520.

Although embodiments are specifically illustrated and described herein, it will be appreciated that modifications and variations of the present invention are covered by the above teachings and within the purview of the appended claims without departing from the spirit and intended scope of the invention.

1. A method comprising:
reviewing a first branching behavior of a first previous set of branching instructions executed by a processor;
reviewing multiple traces that have a same beginning instruction; and
selecting a trace from among the multiple traces based on the branching behavior of the first previous set of branching instructions.

2. The method of claim 1, further comprising:
selecting the trace from among the multiple traces that has a second branching behavior of a second previous set of branching instructions that matches the first branching behavior of the first previous set of branching instructions.

3. The method of claim 1, further comprising generating a new trace if a divergence occurs in a pre-determined location in the trace.

4. The method of claim 3, wherein determining whether the new trace is generated is based on which instruction within a block of instructions creates the branch.

5. The method of claim 3, wherein determining whether the alternate trace is generated is based on which block of instructions the branch occurs in.

6. A set of instructions residing in a storage medium, said set of instructions capable of being executed by a processor to implement a method for processing data, the method comprising:
reviewing a first branching behavior of a first previous set of branching instructions executed by a processor;
reviewing multiple traces that have a same beginning instruction; and
selecting a trace from among the multiple traces based on the branching behavior of the first previous set of branching instructions.

7. The set of instructions of claim 6, further comprising:
selecting the trace from among the multiple traces that has a second branching behavior of a second previous set of branching instructions that matches the first branching behavior of the first previous set of branching instructions.

8. The set of instructions of claim 6, further comprising generating a new trace if a divergence occurs in a pre-determined location in the trace.

9. The set of instructions of claim 8, wherein determining whether the new trace is generated is based on which instruction within a block of instructions creates the branch.

10. The set of instructions of claim 8, wherein determining whether the alternate trace is generated is based on which block of instructions the branch occurs in.

11. A processor comprising:
a branch predictor to review a first branching behavior of a first previous set of branching instructions executed by a processor;
a trace cache to store multiple traces that have a same beginning instruction; and
a fetching mechanism to retrieve a trace from among the multiple traces based on the first branching behavior of the previous set of branching instructions.

12. The processor of claim 11, wherein the fetching mechanism is to select the trace from among the multiple traces that has a second branching behavior of a second previous set of branching instructions that matches the first branching behavior of the first previous set of branching instructions.

13. The processor of claim 11, further comprising a processing core to execute the trace and to generate generate a new trace if a divergence occurs in a pre-determined location in the trace.

14. The processor of claim 13, wherein whether the new trace is generated is based on which instruction within a block of instructions creates the branch.

15. The processor of claim 13, wherein whether the alternate trace is generated is based on which block of instructions the branch occurs in.

16. A system comprising:
a memory to store a set of instructions;
a processor coupled to the memory to execute the set of instructions, the processor with a branch predictor to review a first branching behavior of a first previous set of branching instructions executed by a processor, a trace cache to store multiple traces that have a same beginning instruction, and a fetching mechanism to retrieve a trace from among the multiple traces based on the first branching behavior of the previous set of branching instructions.

17. The system of claim 16, wherein the fetching mechanism is to select the trace from among the multiple traces that has a second branching behavior of a second previous set of branching instructions that matches the first branching behavior of the first previous set of branching instructions.

18. The system of claim 16, further comprising a processing core to execute the trace and to generate a new trace if a divergence occurs in a pre-determined location in the trace.

19. The system of claim 18, wherein whether the new trace is generated is based on which instruction within a block of instructions creates the branch.

20. The system of claim 18, wherein whether the alternate trace is generated is based on which block of instructions the branch occurs in.
